(19) United States
(12) Patent Application Publication
(10) Pub. No.: US 2015/0044569 A1
(43) Pub. Date: Feb. 12, 2015

(54) HIGH ENERGY CATHODE MATERIALS FOR PRIMARY BATTERIES

(71) Applicant: Rutgers, The State University of New Jersey, New Brunswick, NJ (US)

(72) Inventors: Nathalie Pereira, Piscataway, NJ (US); Fadwa Badway, Old Bridge, NJ (US); Glenn G. Amatucci, Peapack, NJ (US)

(21) Appl. No.: 14/452,970

(22) Filed: Aug. 6, 2014

Related U.S. Application Data
(60) Provisional application No. 61/863,009, filed on Aug. 7, 2013.

(51) Int. Cl. H01M 4/36; H01M 4/583

(52) U.S. Cl. CPC H01M 4/364; H01M 4/5835
USPC 429/231.7; 252/182.1

(57) ABSTRACT

A composition, comprising: a composite including (i) a carbon fluoride component comprising a CFₓ material, wherein x≧1, and having a first electrochemical property, and (ii) a carbonaceous material component having a second electrochemical property. The carbon fluoride component is 70 wt % to 99 wt % based on a total weight of the composite. The carbonaceous material component is 1 wt % to 30 wt % based on the total weight of the composite. The composite is adapted to react with energy applied thereto, and wherein, upon such reaction, the composite provides a third electrochemical property that is higher than the first electrochemical property, higher than the second electrochemical property, and higher than a combination of the first and second electrochemical properties.

### CROSS-REFERENCE TO RELATED APPLICATION

This is a §111(a) application that claims the priority of U.S. Provisional Application Ser. No. 61/863,009, entitled “HIGH ENERGY CATHODE MATERIALS FOR PRIMARY BATTERIES,” filed Aug. 7, 2013, which is incorporated herein by reference in its entirety for all purposes.

### FIELD OF INVENTION

The described invention generally relates to high energy cathode materials for use in electrochemical cells.

### BACKGROUND OF THE INVENTION

Carbon monofluoride (CFₓ) is presently one of the highest energy density positive electrode materials utilized in the primary battery industry. Although of exceptional high energy density and stability, the material suffers from poor rate capability. Avenues have been explored to produce carbon fluoride materials of higher rate, however, these invariably lead to significant decreases in energy density.

### BRIEF SUMMARY OF INVENTION

The disclosed subject matter relates to a composition, comprising: a composite including (i) a carbon fluoride component comprising a CFₓ material, wherein x≧1, and having a first electrochemical property, and (ii) a carbonaceous material component having a second electrochemical property. According to one embodiment of the composition, the carbon fluoride component is 70 wt % to 99 wt % based on a total weight of the composite. According to another embodiment, the carbonaceous material component is 1 wt % to 30 wt % based on the total weight of the composite. According to an embodiment, the composite is adapted to react with energy applied thereto, and wherein, upon such reaction, the composite provides a third electrochemical property that is higher than the first electrochemical property, higher than the second electrochemical property, and higher than a combination of the first and second electrochemical properties.

According to an embodiment, each of the first, second and third electrochemical properties is open circuit voltage. According to another embodiment, each of the first, second and third electrochemical properties is power density. According to an embodiment, each of the first, second and third electrochemical properties is average discharge voltage.

According to an embodiment, the carbonaceous material component includes a single wall carbon nanotube. According to another embodiment, the carbonaceous material component includes a multi-walled carbon nanotube. According to an embodiment, the carbonaceous material component includes a material selected from the group consisting of carbon black, graphite, coke, graphene, and hard carbon.

According to an embodiment, a specific capacity of the composite is within a range of 500 mAh/g and 1000 mAh/g.

According to an embodiment, a first x-ray diffraction derived (100):(001) Bragg reflection integrated intensity ratio of the composite is greater than a second x-ray diffraction derived (100):(001) Bragg reflection integrated intensity ratio of the carbon fluoride component.

According to an embodiment, an open circuit voltage of the composite is ≧3.4V when compared to Li/Li⁺.

According to an embodiment, a first open circuit voltage of the composite is ≧3.4V when compared to Li/Li⁺ and wherein a second open circuit voltage of the carbon fluoride material is <3.4V when compared to Li/Li⁺.

According to another embodiment, a first discharge voltage of the composite is ≧0.1V under a constant current of 2 mA/g when compared to second discharge voltage of the carbon fluoride component under a constant current of 2 mA/g, wherein the first discharge voltage and the second discharge voltage are measured at or below a 50% depth of discharge.

According to an embodiment, the composite on average is comprised of domains<100 nm of CFₓ.

The disclosed subject matter relates to a composition, comprising: a sufficient first amount of a carbon fluoride component comprising a CFₓ material, wherein x≧1, and having a first electrochemical property; and a sufficient second amount of a carbonaceous material component having a second electrochemical property, wherein the first amount of a carbon fluoride component and the second amount of carbonaceous material form a composite, wherein the composite includes a third electrochemical property that is higher than the first electrochemical property, higher than the second electrochemical property, and higher than a combination of the first and second electrochemical properties.

According to an embodiment, each of the first, second and third electrochemical properties is open circuit voltage. According to another embodiment, each of the first, second and third electrochemical properties is power density. According to an embodiment, each of the first, second and third electrochemical properties is average discharge voltage.

According to an embodiment, a specific capacity of the composite is within a range of 500 mAh/g and 1000 mAh/g.

According to an embodiment, a first x-ray diffraction derived (100):(001) Bragg reflection integrated intensity ratio of the composite is greater than a second x-ray diffraction derived (100):(001) Bragg reflection integrated intensity ratio of the carbon fluoride component.

According to another embodiment, a first open circuit voltage of the composite is ≧3.4V when compared to Li/Li⁺. According to an embodiment, a first open circuit voltage of the composite is ≧3.4V when compared to Li/Li⁺ and wherein a second open circuit voltage of the carbon fluoride material is <3.4V when compared to Li/Li⁺.

According to an embodiment, a first discharge voltage of the composite is ≧0.1V under a constant current of 2 mA/g when compared to second discharge voltage of the carbon fluoride component under a constant current of 2 mA/g, wherein the first discharge voltage and the second discharge voltage are measured at or below a 50% depth of discharge.

According to an embodiment, the sufficient first amount of the carbon fluoride component is 70 wt % to 99 wt % based on a total weight of the composite. According to another embodiment, the sufficient second amount of the carbonaceous material component is 1 wt % to 30 wt % based on the total weight of the composite.

The disclosed subject matter relates to a method, comprising: selecting a carbon fluoride component comprising a CFₓ material, wherein x≧1, having a first electrochemical property, selecting a carbonaceous material component having a second electrochemical property; mixing the carbon fluoride component and the carbonaceous material component to form a mixture; wherein the carbon fluoride component is 70 wt % to 99 wt % based on a total weight of the mixture; wherein the carbonaceous material component is 1 wt % to 30 wt % based on the total weight of the mixture; and subjecting the mixture to energy, resulting in the mixture having a third electrochemical property that is higher than the first electrochemical property, higher than the second electrochemical property, and higher than a combination of the first and second electrochemical properties.

According to an embodiment, the step of subjecting the mixture to energy includes subjecting the mixture to thermal energy. According to an embodiment, the thermal energy is provided by an annealing process. According to another embodiment, the annealing process is performed at a temperature ranging from 150° C. to 900° C. According to an embodiment, the step of subjecting the mixture to energy includes subjecting the mixture to mechanical energy. According to an embodiment, the mechanical energy is provided by milling.

According to an embodiment, each of the first, second and third electrochemical properties is open circuit voltage. According to an embodiment, each of the first, second and third electrochemical properties is power density. According to an embodiment, each of the first, second and third electrochemical properties is average discharge voltage.

### BRIEF DESCRIPTION OF THE DRAWINGS

The present invention will be further explained with reference to the attached figures. The figures constitute a part of this specification and include illustrative embodiments of the present invention and illustrate various objects and features thereof. Specific functional details disclosed herein are not to be interpreted as limiting, but merely as a representative basis for teaching one skilled in the art to variously employ the present invention.

FIG. 1 illustrates some embodiments of the composition of the present invention, showing voltage plotted against specific capacity. Some embodiments of the composition of the present invention illustrate high energy milling synthesis of transformed carbon fluoride composites with multiwalled carbon nanotubes (abbreviated “CFₓ-MWCNT”) compared to the unprocessed carbon fluoride (abbreviated “CFₓ”) component and the unprocessed CFₓ-MWCNT mixture.

FIG. 2 illustrates some embodiments of the present invention, showing a bar graph of specific capacity obtained as a function of specific current.

FIGS. 3A and 3B illustrate some embodiments of the present invention, showing graphs illustrating voltage plotted against specific capacity. Some embodiments of the present invention illustrate high energy milling synthesis of transformed CFₓ composites with a carbonaceous material component, where the carbonaceous material component include graphene, carbon black, graphite, coke and/or MWCNT.

FIGS. 4A and 4B illustrate some embodiments of the present invention, showing graphs illustrating voltage plotted against specific capacity. Some embodiments of the present invention illustrate high energy milling synthesized composites along with thermal annealing synthesized composites with MWCNT compared to the unprocessed CFₓ compound, and the unprocessed CFₓ-MWCNT material mixture.

FIG. 5 illustrates some embodiments of the present invention, showing linear counts plotted against a 2-theta-scale. Some embodiments of the present invention illustrate structural characterization of the high energy milling synthesized composites along with thermal annealing synthesized CFₓ-MWCNT composites compared to the unprocessed CFₓ compound, and the unprocessed CFₓ-MWCNT material mixture.

FIG. 6 illustrates some crystallographic embodiments of the present invention as characterized by X-ray diffraction utilizing CuKα radiation, which is configured to deliver a wavelength equaling 0.15418 nm, showing linear counts plotted against 2-theta-scale. Some embodiments of the present invention illustrate high energy milling synthesis of transformed CFₓ composites with carbonaceous material components including graphene, carbon black, graphite, coke referenced vs. MWCNT and the unprocessed CFₓ.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION OF EXEMPLARY EMBODIMENTS

Among those benefits and improvements that have been disclosed, other objects and advantages of this invention can become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive. Any alterations and further modifications of the inventive feature illustrated herein, and any additional applications of the principles of the invention as illustrated herein, which can normally occur to one skilled in the relevant art and having possession of this disclosure, are to be considered within the scope of the invention.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “compaction” as used herein refers to the act of exerting a force and/or load including pressing and/or compressing on one or more compound(s), which generally causes densification by size and/or volume reduction.

The term “high energy milling” as used herein refers to the action of submitting one or multiple components to a milling process where the mixture is subjected to high kinetic and/or mechanical energy upon collision with milling media. High energy milling can be performed using different devices including but not limited to tumbler mills, shaker mills, ball mills, planetary mills and attritors. Unless specified elsewhere, the high energy composites presented in the examples were fabricated using planetary mills.

The term “composite” as used herein refers to a compound including at least two different parts/components. In some embodiments of the present invention, the term “composite” includes (1) a carbon fluoride component and (2) a carbonaceous material component. In some embodiments of the present invention, the composite includes (1) CFₓ with x≧1 and (2) non-fluorinated carbonaceous material. In some embodiments of the present invention, the composite includes (1) CFₓ with x<1 and (2) a fluorinated carbonaceous material. In some embodiments of the present invention, the composite includes CFₓ with x>1 and (2) a fluorinated carbonaceous material.

The term “current” as used herein refers to the time rate of flow of electric charge, in the direction that a positive moving charge would take and having magnitude equal to the quantity of charge per unit time. In some embodiments of the present invention, current is measured in amperes. In some embodiments of the present invention, multiplying the current with a load time (measured in hours) provides the “capacity” (measured in ampere-hours (abbreviated “Ah”)).

The term “current density” as used herein refers to the current applied to a cell/battery and is measured in milliampere per unit weight of the unprocessed CFₓ compound, the unprocessed CFₓ-MWCNT mixture or processed composite (“mA/g”).

The term “depth of discharge” (abbreviated “DoD”) is the percentage of battery capacity that has been discharged and is expressed as a percentage of maximum capacity. A battery that has not been discharged and therefore remains full has a DoD of 0%. In contrast, a battery that has been fully discharged and therefore is empty has a DoD of 100%.

The term “discharge” as used herein refers to the reduction of the positive electrode of the battery.

The term “domain” as used herein refers to a single crystalline region of a material resulting in the coherent diffraction of x-ray radiation.

The term “electrode” as used herein refers to a conductor through which electricity enters or leaves an object, substance, and/or region (e.g., a battery).

The term “energy density” as used herein refers to the nominal battery energy per unit volume and is measured in watt-hour per liter (abbreviated “Wh/L”).

The term “power density” as used herein refers to the battery power (time rate of energy transfer) per unit volume and is measured in watt per liter (abbreviated “W/L”).

The term “nanocomposite” as used herein refers to a composite of a particle size less than 100 nm.

The term “pulse capability” as used herein refers to a battery's capability to deliver power per unit weight of a battery (the power density), for a high value for a short period of time.

The term “redox reaction” or “reduction/oxidation reaction” as used herein refers to all chemical reactions in which atoms have their oxidation state changed by transferring/accepting at least one electron. Oxidation is the loss of electrons or an increase in the oxidation state by a molecule, atom, or ion. Reduction is the gain of electrons or a decrease in the oxidation state by a molecule, atom or ion.

The term “specific capacity” as used herein refers to the amount of energy a compound contains measured in milliampere-hours per unit weight of electrode material (abbreviated “mAh/g”).

The term “transformed” as used herein refers to a processed composite, where the processing can include, but is not limited to, heat-treating, mixing, compacting, or any other active physical force exerted on the composite. A transformed electrode as described herein is evidenced by a advantageous change in electrochemical properties.

The term “unprocessed carbon fluoride” as used herein refers to carbon fluoride material that has not been altered and used as received from the vendor.

The term “unprocessed CFₓ-MWCNT mixture” as used herein refers to a blend of carbon fluoride and multiwalled carbon nanotube materials that have been mixed without force using a mortar and pestle.

The term “voltage” (abbreviated “V”) as used herein is equal to the work done per unit charge against a static electric field to move the charge between two points. Unless specified elsewhere, voltage is defined as potential of electrode material of interest vs a lithium metal negative electrode.

The term “open circuit voltage” (abbreviated “OCV”) as used herein refers to the difference of electrical potential/voltage between the positive and negative electrode in the absence of a load.

The term “voltage delay” as used herein refers to when a battery discharges a lower initial voltage than expected and recovers gradually as the discharge progresses. This is also commonly known as “overpotential”.

The term “weight percentage” as used herein refers to the concentration of a component and/or material (e.g., carbon fluoride, carbonaceous material) in a mixture or a composite of at least two components. The weight percentage is calculated as the weight of the component divided by the total weight of the mixture or composite expressed in percentage and/or decimal. Unless stated otherwise, the composite compositions provided herein are described in weight percentage.

The term “X-ray diffraction” as used herein refers to a method in which an incident beam is directed at a crystalline material, creating a diffracted beam (e.g., exhibiting X-ray diffraction pattern(s)) that is recorded and analyzed. X-ray diffraction can be used to study a physical and/or chemical reaction. The term “powder diffraction” as used herein refers to a type of X-ray diffraction (or neutron, or electron diffraction) on powder or microcrystalline samples for structural characterization of materials. Several examples illustrated herein show X-ray diffraction being performed using Cu Kα radiation.

The term “Bragg's Law” is expressed by the equation: nλ=2d sin θ, where the variable “d” is the distance between anatomic layers in a crystal, and the variable “λ” is the wavelength of the incident X-ray beam; “n” is an integer.

The term “Bragg peak” and “Bragg reflection” and “diffraction reflection” as used herein refer to the (hkl) diffraction features obtained from successive crystallographic planes (where h, k, and l, are Miller indices) upon constructive radiation interferences obeying Bragg's Law.

The term “crystallographic planes” as used herein refers to the set of atomic planes in a structural lattice that are parallel and equidistant.

The term “Miller indices” as used herein refers to a three-value notation that defines the reciprocals of the fractional intercepts that the plane of the set of crystallographic planes, which is closest to the origin, makes with the crystallographic axes.

The terms “intensity” and “integrated intensity” as used herein refer to the area located under the (hkl) diffraction features obeying Bragg's law.

The term “(H00):(00L) ratio” as used herein refers to the integrated intensity ratio of the (H00) Bragg peak to the (00L) Bragg peak and is used to determine diffraction features to characterize a sample (e.g., a material).

In some embodiments of the present invention, a composition includes at least one mixture of carbon fluoride and non-fluorinated carbonaceous material. Carbon fluoride/non-fluorinated carbonaceous material mixtures generally result in minimal improvement in electrochemical performance. In some embodiments, the present invention relates to the surprising fact that when the two components are subjected to an event which imparts energy, where the energy is thermal energy (by annealing at temperatures >150° C.) and/or mechanical energy (high energy milling), the composite, formed by both components, exhibits electrochemical properties that are substantially different when compared to properties of the individual components of the mixture, and/or compared to the unreacted mixture. In some embodiments, the improvements manifest themselves in the form of greater electrochemical performance as measured by voltage and/or rate.

In some embodiments, this invention relates to the finding that graphite fluorides can react with non-fluorinated carbonaceous compounds to result in a composite of considerable higher voltage and much improved high rate of discharge and pulse capability. Such composites, examples of which are elaborated below, have demonstrated improved performance over current state of the art materials in that they offer the high energy density of covalent type carbon fluorides with the high rate and pulse capability of ionic carbon fluorides. Without being limited by theory, it is believed the high energy milling and the thermal annealing of the intimate mixtures provide enough thermodynamic driving force to reduce the carbon fluoride CFₓ to CF_{x-δ}, and that this occurs in tandem with the oxidation of the carbonaceous material component from C to CF_{δ}. In some embodiments, increasing the heat-treatment temperature will thereby provide higher energy to induce composite transformation as illustrated in the examples below.

In some embodiments, the present invention includes a composition comprising a composite comprising a carbon fluoride component and a non-fluorinated carbonaceous material component, the composite being characterized by a weight percent of the carbon fluoride component and the non-fluorinated carbonaceous material component, wherein the CFₓ content is greater than 70 wt % and the non-fluorinated carbonaceous material content is less than 30 wt %, and wherein specific capacity of the composite is >500 mAh/g.

According to another embodiment, the composite is a nanocomposite. According to another embodiment, the carbonaceous material component includes a single or multiwalled carbon nanotube. According to another embodiment, the carbonaceous material component is carbon black. According to another embodiment, the carbonaceous material component is graphite. According to another embodiment, the carbonaceous material component is coke. According to another embodiment, the carbonaceous material component is graphene. According to another embodiment, the carbonaceous material component is hard carbon. According to another embodiment, the composite is formed by application of high energy milling. According to another embodiment, the composite shows an increase of the x-ray diffraction derived (100):(001) Bragg reflection integrated intensity ratio compared to that of the initial carbon fluoride component and/or unreacted composite. According to another embodiment, the composite has an OCV≧3.4V vs. Li/Li+. According to another embodiment, the composite has an OCV≧3.4V vs. Li/Li+, while the initial carbon fluoride has an OCV<3.4V vs. Li/Li+. According to another embodiment the composite has an average discharge voltage≧0.1V higher than the initial carbon fluoride component when tested versus Li metal at 2 mA/g of composite.

According to another embodiment, the nanocomposite is formed by heating an intimate mixture of the carbon fluoride component and the non-fluorinated carbonaceous material components at a temperature >150° C. but <900° C. According to another embodiment, the composition comprises a carbon fluoride nanocomposite comprising CFₓ, wherein the nanocomposite on average is comprised of domains <100 nm of CFₓ where x>0.7 and <100 nm CFₓ where x<0.3. According to another embodiment, the composition comprises a carbon fluoride nanocomposite comprising CFₓ, wherein the nanocomposite on average is comprised of domains <100 nm of CFₓ wherein x>0.7. According to another embodiment, the composite shows an increase of the x-ray diffraction derived (100):(001) Bragg reflection integrated intensity ratio compared to that of the initial carbon fluoride component and/or unreacted composite. According to another embodiment, the composite has an OCV≧3.4V vs. Li/Li. According to another embodiment, the composite has an OCV≧3.4V vs. Li/Li+, while the initial carbon fluoride has an OCV<3.4V vs. Li/Li+. According to another embodiment, the composite has an OCV of between 3.4-5.0V vs. Li/Li+, while the initial carbon fluoride has an OCV between 2.0-3.35V vs. Li/Li+. According to another embodiment, the composite has an OCV of between 4.0-5.0V vs. Li/Li+, while the initial carbon fluoride has an OCV between 2.0-3.35V vs. Li/Li+. According to another embodiment, the composite has an OCV of between 3.4-4.0V vs. Li/Li+, while the initial carbon fluoride has an OCV between 2.0-3.35V vs. Li/Li+. According to another embodiment, the composite has an OCV of between 3.4-5.0V vs. Li/Li+, while the initial carbon fluoride has an OCV between 2.5-3.35V vs. Li/Li+. According to another embodiment, the composite has an OCV of between 4.0-5.0V vs. Li/Li+, while the initial carbon fluoride has an OCV less than between 2.5-3.35V vs. Li/Li+. According to another embodiment, the composite has an OCV of between 3.4-4.0V vs. Li/Li+, while the initial carbon fluoride has an OCV less than between 2.5-3.35V vs. Li/Li+. According to another embodiment the composite has an average discharge voltage≧0.1V greater than the initial carbon fluoride component when tested versus Li metal at 2 mA/g of composite.

According to another embodiment, the composite has an OCV of between 3.4-5.0V vs. Li/Li+. According to another embodiment, the composite has an OCV of between 3.5-5.0V vs. Li/Li+. According to another embodiment, the composite has an OCV of between 4.0-5.0V vs. Li/Li+. According to another embodiment, the composite has an OCV of between 4.5-5.0V vs. Li/Li+. According to another embodiment, the composite has an OCV of between 3.4-4.5V vs. Li/Li+. According to another embodiment, the composite has an OCV of between 3.4-4.0V vs. Li/Li+.

According to another embodiment, the carbonaceous material component is a single or multiwalled carbon nanotube. According to another embodiment, the carbonaceous material component is carbon black. According to another embodiment, the carbonaceous material component is graphite. According to another embodiment, the carbonaceous material component is coke. According to another embodiment, the carbonaceous material component is graphene. According to another embodiment, the carbonaceous material component is hard carbon. According to another embodiment, the composite is formed by application of high energy milling. According to another embodiment, the composite is formed by heating a mixture of the carbon fluoride component and the carbonaceous material components at a temperature >150° C. but <900° C. According to another embodiment, the composite shows an increase of the x-ray diffraction derived (100):(001) Bragg reflection integrated intensity ratio compared to that of the initial carbon fluoride component and/or unreacted composite. According to another embodiment, the composite has an OCV≧3.4V vs. Li/Li. According to another embodiment, the composite has an OCV≧3.4V vs. Li/Li+, while the initial carbon fluoride has an OCV<3.4V vs. Li/Li+. According to another embodiment the composite has an average discharge voltage ≧0.1V higher than the initial carbon fluoride component when tested versus Li metal at 2 mA/g of composite.

In some embodiments of the composition of the present invention, a composite includes a MWCNT composite, a graphene composite, a carbon black composite, a graphite composite, and/or a coke composite. In some embodiments of the composition of the present invention, a high energy CFₓ/composite is configured to have an OCV between 1% and 20% greater than an OCV of an unprocessed CFₓ material. In some embodiments of the composition of the present invention, a high energy CFₓ/composite is configured to have an OCV between 1% and 15% greater than an OCV of an unprocessed CFₓ material. In some embodiments of the composition of the present invention, a high energy CFₓ/composite is configured to have an OCV between 1% and 10% greater than an OCV of an unprocessed CFₓ material. In some embodiments of the composition of the present invention, a high energy CFₓ/composite is configured to have an OCV between 1% and 5% greater than an OCV of an unprocessed CFₓ material.

In some embodiments of the composition of the present invention, a high energy CFₓ/composite is configured to have an OCV between 5% and 20% greater than an OCV of an unprocessed CFₓ material. In some embodiments of the composition of the present invention, a high energy CFₓ/composite is configured to have an OCV between 10% and 20% greater than an OCV of an unprocessed CFₓ material. In some embodiments of the composition of the present invention, a high energy CFₓ/composite is configured to have an OCV between 15% and 20% greater than an OCV of an unprocessed CFₓ material.

In some embodiments of the composition of the present invention, a high energy CFₓ/composite is configured to have an OCV 5% greater than an OCV of an unprocessed CFₓ material. In some embodiments of the composition of the present invention, a high energy CFₓ/composite is configured to have an OCV 6% greater than an OCV of an unprocessed CFₓ material. In some embodiments of the composition of the present invention, a high energy CFₓ/composite is configured to have an OCV 7% greater than an OCV of an unprocessed CFₓ material. In some embodiments of the composition of the present invention, a high energy CFₓ/composite is configured to have an OCV 8% greater than an OCV of an unprocessed CFₓ material. In some embodiments of the composition of the present invention, a high energy CFₓ/composite is configured to have an OCV 9% greater than an OCV of an unprocessed CFₓ material. In some embodiments of the composition of the present invention, a high energy CFₓ/composite is configured to have an OCV 10% greater than an OCV of an unprocessed CFₓ material.

In some embodiments of the composition of the present invention, a high energy CFₓ/composite is configured to have an OCV 11% greater than an OCV of an unprocessed CFₓ material. In some embodiments of the composition of the present invention, a high energy CFₓ/composite is configured to have an OCV 12% greater than an OCV of an unprocessed CFₓ material. In some embodiments of the composition of the present invention, a high energy CFₓ/composite is configured to have an OCV 13% greater than an OCV of an unprocessed CFₓ material. In some embodiments of the composition of the present invention, a high energy CFₓ/composite is configured to have an OCV 14% greater than an OCV of an unprocessed CFₓ material. In some embodiments of the composition of the present invention, a high energy CFₓ/composite is configured to have an OCV 15% greater than an OCV of an unprocessed CFₓ material.

In some embodiments of the composition of the present invention, a composite includes a MWCNT composite, a graphene composite, a carbon black composite, a graphite composite, and/or a coke composite. In some embodiments of the composition of the present invention, a high energy CFₓ/composite is configured to have a discharge voltage between 1% and 20% higher than an unprocessed CFₓ under conditions including 2 mA/g load at 100 mAh/g. In some embodiments of the composition of the present invention, a high energy CFₓ/composite is configured to have a discharge voltage between 5% and 20% higher than an unprocessed CFₓ under conditions including 2 mA/g load at 100 mAh/g. In some embodiments of the composition of the present invention, a high energy CFₓ/composite is configured to have a discharge voltage between 10% and 20% higher than an unprocessed CFₓ under conditions including 2 mA/g load at 100 mAh/g. In some embodiments of the composition of the present invention, a high energy CFₓ/composite is configured to have a discharge voltage between 15% and 20% higher than an unprocessed CFₓ under conditions including 2 mA/g load at 100 mAh/g.

In some embodiments of the composition of the present invention, a high energy CFₓ/composite is configured to have a discharge voltage between 1% and 15% higher than an unprocessed CFₓ under conditions including 2 mA/g load at 100 mAh/g. In some embodiments of the composition of the present invention, a high energy CFₓ/composite is configured to have a discharge voltage between 1% and 10% higher than an unprocessed CFₓ under conditions including 2 mA/g load at 100 mAh/g. In some embodiments of the composition of the present invention, a high energy CFₓ/composite is configured to have a discharge voltage between 1% and 5% higher than an unprocessed CFₓ under conditions including 2 mA/g load at 100 mAh/g.

In some embodiments of the composition of the present invention, a high energy CFₓ/composite is configured to have a discharge voltage 5% higher than an unprocessed CFₓ under conditions including 2 mA/g load at 100 mAh/g. In some embodiments of the composition of the present invention, a high energy CFₓ/composite is configured to have a discharge voltage 6% higher than an unprocessed CFₓ under conditions including 2 mA/g load at 100 mAh/g. In some embodiments of the composition of the present invention, a high energy CFₓ/composite is configured to have a discharge voltage 7% higher than an unprocessed CFₓ under conditions including 2 mA/g load at 100 mAh/g. In some embodiments of the composition of the present invention, a high energy CFₓ/composite is configured to have a discharge voltage 8% higher than an unprocessed CFₓ under conditions including 2 mA/g load at 100 mAh/g. In some embodiments of the composition of the present invention, a high energy CFₓ/composite is configured to have a discharge voltage 9% higher than an unprocessed CFₓ under conditions including 2 mA/g load at 100 mAh/g. In some embodiments of the composition of the present invention, a high energy CFₓ/composite is configured to have a discharge voltage 10% higher than an unprocessed CFₓ under conditions including 2 mA/g load at 100 mAh/g.

In some embodiments of the composition of the present invention, a specific capacity of the composite is between 500 mAh/g-1000 mAh/g. In some embodiments of the composition of the present invention, a specific capacity of the composite is between 500 mAh/g-900 mAh/g. In some embodiments of the composition of the present invention, a specific capacity of the composite is between 500 mAh/g-800 mAh/g. In some embodiments of the composition of the present invention, a specific capacity of the composite is between 500 mAh/g-700 mAh/g. In some embodiments of the composition of the present invention, a specific capacity of the composite is between 500 mAh/g-600 mAh/g.

In some embodiments of the composition of the present invention, a specific capacity of the composite is between 600 mAh/g-1000 mAh/g. In some embodiments of the composition of the present invention, a specific capacity of the composite is between 700 mAh/g-1000 mAh/g. In some embodiments of the composition of the present invention, a specific capacity of the composite is between 800 mAh/g-1000 mAh/g. In some embodiments of the composition of the present invention, a specific capacity of the composite is between 900 mAh/g-1000 mAh/g.

In some embodiments of the composition of the present invention, the unprocessed CFₓ weight percent is between 70 wt %-99 wt % compared to a total weight of the composite. In some embodiments of the composition of the present invention, the unprocessed CFₓ weight percent is between 75 wt %-99 wt % compared to a total weight of the composite. In some embodiments of the composition of the present invention, the unprocessed CFₓ weight percent is between 80 wt %-99 wt % compared to a total weight of the composite. In some embodiments of the composition of the present invention, the unprocessed CFₓ weight percent is between 85 wt %-99 wt % compared to a total weight of the composite. In some embodiments of the composition of the present invention, the unprocessed CFₓ weight percent is between 90 wt %-99 wt % compared to a total weight of the composite. In some embodiments of the composition of the present invention, the unprocessed CFₓ weight percent is between 95 wt %-99 wt % compared to a total weight of the composite.

In some embodiments of the composition of the present invention, the unprocessed CFₓ weight percent is between 70 wt %-95 wt % compared to a total weight of the composite. In some embodiments of the composition of the present invention, the unprocessed CFₓ weight percent is between 70 wt %-90 wt % compared to a total weight of the composite. In some embodiments of the composition of the present invention, the unprocessed CFₓ weight percent is between 70 wt %-85 wt % compared to a total weight of the composite. In some embodiments of the composition of the present invention, the unprocessed CFₓ weight percent is between 70 wt %-80 wt % compared to a total weight of the composite. In some embodiments of the composition of the present invention, a weight content is between 70 wt %-75 wt % compared to a total weight of the composite.

In some embodiments of the composition of the present invention, the carbon fluoride component is greater than 70 wt % and the carbonaceous material component is less than 30 wt % compared to a total weight of the composite. In some embodiments of the composition of the present invention, the carbon fluoride component is between 70-99 wt % and the carbonaceous material component is between 1-30 wt % compared to a total weight of the composite. In some embodiments of the composition of the present invention, the carbon fluoride component is between 70-95 wt % and the carbonaceous material component is between 5-30 wt % compared to a total weight of the composite. In some embodiments of the composition of the present invention, the carbon fluoride component is between 70-90 wt % and the carbonaceous material component is between 10-30 wt % compared to a total weight of the composite. In some embodiments of the composition of the present invention, the carbon fluoride component is between 70-85 wt % and the carbonaceous material component is between 15-30 wt % compared to a total weight of the composite. In some embodiments of the composition of the present invention, the carbon fluoride component is between 70-80 wt % and the carbonaceous material component is between 20-30 wt % compared to a total weight of the composite. In some embodiments of the composition of the present invention, the carbon fluoride component is between 70-75 wt % and the carbonaceous material component is between 25-30 wt % compared to a total weight of the composite.

In some embodiments of the composition of the present invention, the carbon fluoride component is between 75-99 wt % and the carbonaceous material component is between 1-25 wt % compared to a total weight of the composite. In some embodiments of the composition of the present invention, the carbon fluoride component is between 80-99 wt % and the carbonaceous material component is between 1-20 wt % compared to a total weight of the composite. In some embodiments of the composition of the present invention, the carbon fluoride component is between 85-99 wt % and the carbonaceous material component is between 1-15 wt % compared to a total weight of the composite. In some embodiments of the composition of the present invention, the carbon fluoride component is between 90-99 wt % and the carbonaceous material component is between 1-10 wt % compared to a total weight of the composite. In some embodiments of the composition of the present invention, the carbon fluoride component is between 95-99 wt % and the carbonaceous material component is between 1-5 wt % compared to a total weight of the composite.

### EXAMPLES

The following examples are put forth so as to provide those of ordinary skill in the art with a complete disclosure and description of how to make and use the described invention, and are not intended to limit the scope of what the inventors regard as their invention nor are they intended to represent that the experiments below are all or the only experiments performed. Efforts have been made to ensure accuracy with respect to numbers used (e.g., amounts, temperatures, etc.) but some experimental errors and deviations should be accounted for. Unless indicated otherwise, parts are by weight, molecular weight is weight average molecular weight, temperature is in degrees Centigrade, and pressure is at or near atmospheric.

### Example 1

### Cell Fabrication and Characterization

The active materials, consisting of pure carbon fluoride and/or composites comprising 94% carbon fluoride and 6% carbonaceous compounds (weight percentages), were mixed in acetone with poly(vinylidene fluoride-co-hexafluoropropylene) (Kynar 2801, Elf Atochem), carbon black (Super P, MMM), and propylene carbonate (Aldrich). The electrodes were cast, dried at room temperature, and rinsed in 99.8% anhydrous ether (Aldrich) to extract the propylene carbonate plasticizer. After extraction, the electrodes on average consisted of 87.4% active material, 4.3% carbon black, and 8.3% binder with loading of 15.8-17.4 mg/cm². Two-electrode coin cells (Hohsen, CR2032) were assembled in a Helium-filled dry box using a lithium foil counter electrode and two 25 μm-thick Celgard separators saturated with 1M LiBF₄ (BASF) in anhydrous 1,2 dimetoxyethane (Aldrich): propylene carbonate (BASF) electrolyte (70:30 in vol. %). The anhydrous 1,2 dimetoxyethane solvent was dried on molecular sieves to less than 10 ppm water content prior to utilization while all other electrolyte components were used as received. All electrochemical testing was performed using a Maccor Series 4000 Battery Test System. The cells were typically cycled at 24° C. under a constant current of 2 mA/g of pure CFₓ or 94% CFₓ-6% C composites down to 1.5V. For rate capability, signature curves were obtained by discharging down to 1.5V at 1600, 800, 400, 200, 100, 50, 25, 10, 5 and 2 mA/g with 15 minute rest intervals.

### Example 2

### Synthesis of CFₓ-MWCNT Composites by High Energy Milling

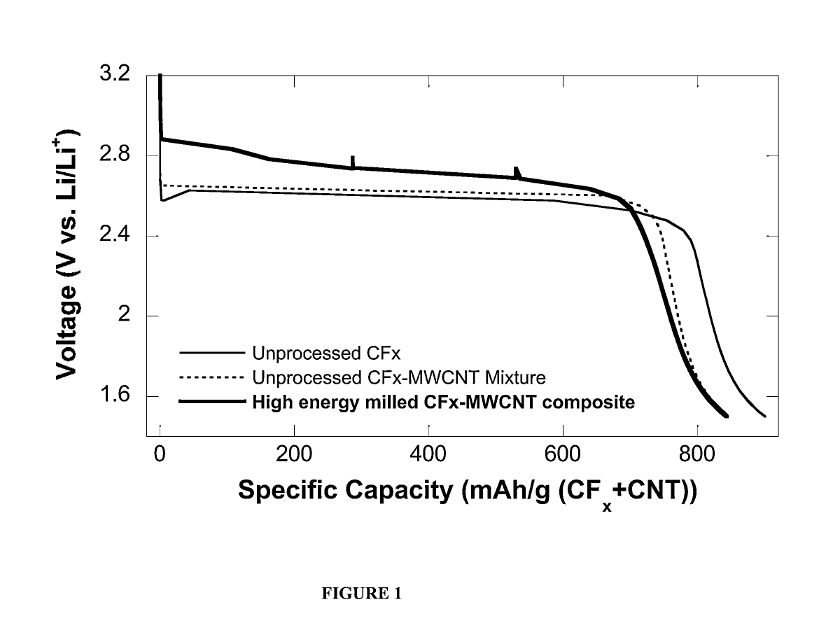

CFₓ-MWCNT composites were synthesized by the process of high energy milling. Mixtures comprising 94% of substantially covalently bonded CFₓ, (where x≧1.0) and 6% MWCNT (CC8265, Advance Nanopower Inc.) totaling 3 g were loaded into a 50 ml ZrO₂-lined milling cell in a Helium-filled glove box and milled for 160 minutes at 400 rpm utilizing a planetary mill (PM100, Retsch). These nanocomposites were tested for electrochemical performance at 2 mA/g and compared to pure unprocessed CFₓ and mixtures of 94% CFₓ and 6% MWCNT that had been hand mixed (and therefore “unprocessed”) using a mortar and pestle (FIG. 1). Addition of MWCNT by simple hand mixing improved the initial voltage delay typically obtained with CFₓ and maintained high capacity (capacity in FIG. 1 is based on the CFₓ+CNT mixture). High energy milling into a CFₓ-MWCNT composite further improved initial delay and significantly increased average discharge voltage (Table 1) without significantly reducing capacity. A systematic shift in the initial OCV of the cell from 3.24V for the unprocessed CFx x≧1 material, to 3.59V for the processed composite material, is also observed (Table 1). Hand mixing the CFₓ component with the CFₓ resulted in an initial OCV of 3.36V, which remains <3.4V (Table 1).

Table 1 shows the OCV of the cells submitted to the signature curve protocol and the 2 mA/g discharge and the discharge voltage under 2 mA/g load at 100 mAh/g and 400 mA/g capacity, illustrating high energy milling synthesis of transformed carbon fluoride composites with multiwalled carbon nanotubes compared to the unprocessed carbon fluoride component and the unprocessed carbon fluoride mixture with multiwalled carbon nanotubes.

TABLE 1

| | Signature | | | | 2 mA/g Discharge | | | |
|---|---|---|---|---|---|---|---|---|
| | | | | | V | | V | |
| | | | | | at | | at | |
| | OCV | | OCV | | 100 mAh/g | | 400 mAh/g | |
| Unprocessed CFₓ | 3.26 | V | 3.24 | V | 2.62 | V | 2.59 | V |
| Unprocessed CFₓ/MWCNT Mixture | 3.32 | | 3.36 | V | 2.64 | V | 2.62 | V |
| High Energy CFₓ/MWCNT Composite | 3.62 | V | 3.59 | V | 2.84 | V | 2.72 | V |

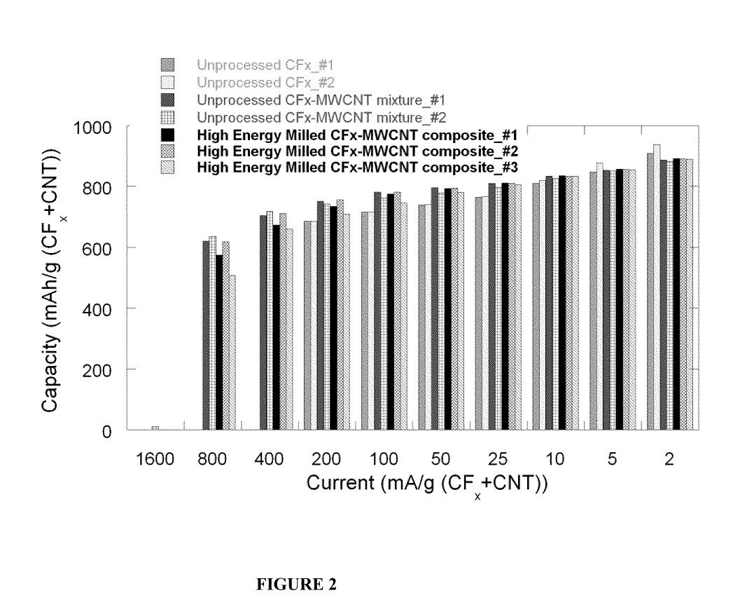

Rate study analysis (FIG. 2) confirmed the positive impact of the addition of MWCNT to CFₓ. Both the hand-mixed and the high-energy milled compounds showed much improved rate performance providing >70% utilization at 1× capacity (abbreviated “1 C-rate”) (800 mA/g composite). Although hand mixing seemed to provide slightly higher capacities at 1 C-rate compared to the high energy milled composite, its poorer packing density results in electrodes of lower energy density even after compaction. A systematic shift in the initial OCV of the cell from 3.26V for the unprocessed CFₓ x≧1 material, to 3.62V for processed composite material, is also observed (Table 1). Hand mixing the CFₓ component with the CFₓ resulted in an initial OCV of 3.32V, which remains <3.4V (Table 1).

### Example 3

### Fabrication of CFₓ Composites with Other Carbonaceous Compounds by High Energy Milling

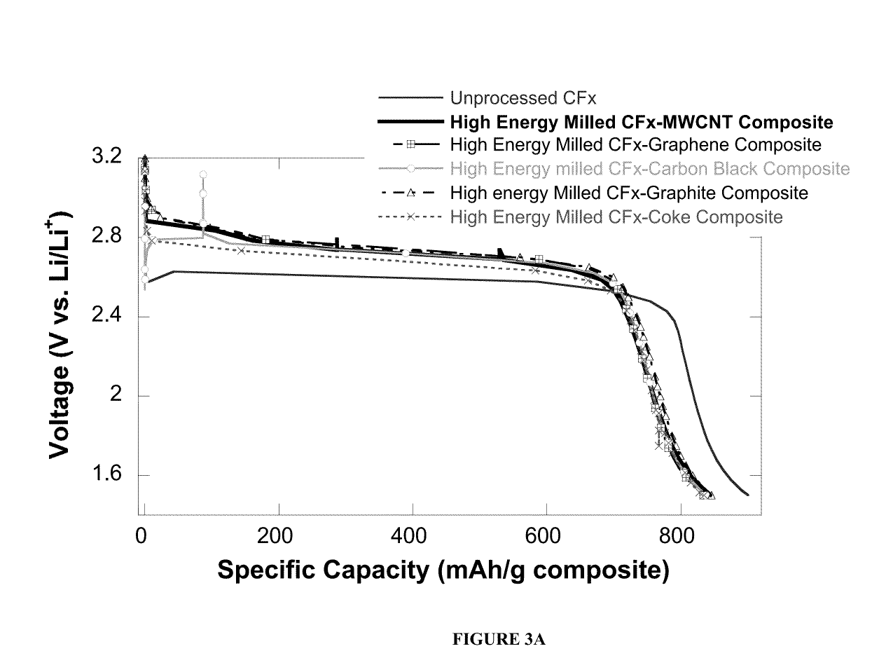

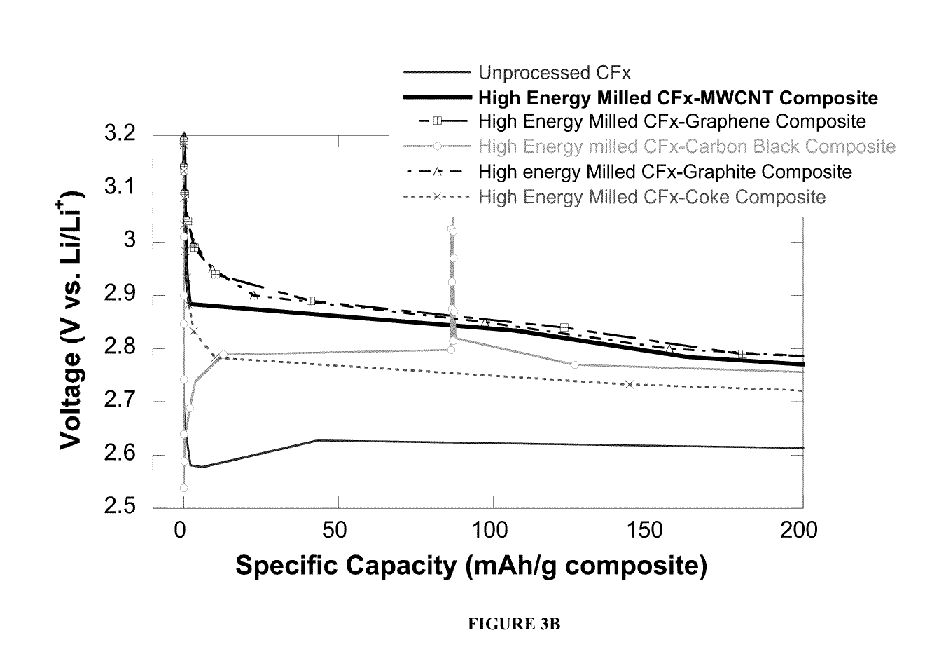

High energy milled CFₓ composites were also fabricated with other carbonaceous compounds, such as graphene, carbon black (Super P, MMM), graphite (KS6) and coke. High energy synthesis was similar to that described in the previous example with MWCNT. Upon constant current discharge at 2 mA/g composite, all tested composites fabricated with carbonaceous additives except Super P carbon black improved the initial voltage delay compared to the pure CFₓ material (FIG. 3). In addition, all composites exhibited significantly increased OCV (>3.4V) and increased discharge voltage while maintaining same high capacity (Table 2).

Table 2 shows the OCV and the discharge voltage under 2 mA/g load at 100 mAh/g and 400 mA/g capacity, illustrating high energy synthesis of transformed carbon fluoride composites with carbonaceous compounds including graphene, carbon black, graphite, coke, and/or MWCNT and the unprocessed CFₓ component.

TABLE 2

| | | 2 mA/g Discharge | |
|---|---|---|---|
| | | V | V |
| | | at | at |
| Materials | OCV | 100 mAh/g | 400 mAh/g |
| Unprocessed CFₓ | 3.24 V | 2.62 V | 2.59 V |
| High Energy CFₓ/MWCNT Composite | 3.59 V | 2.84 V | 2.72 V |
| High Energy CFₓ/Graphene Composite | 3.66 V | 2.85 V | 2.74 V |
| High Energy CFₓ/Carbon Black | 3.58 V | 2.78 V | 2.72 V |
| Composite | | | |
| High Energy CFₓ/Graphite Composite | 3.67 V | 2.85 V | 2.73 V |
| High Energy CFₓ/Coke Composite | 3.61 V | 2.75 V | 2.68 V |

### Example 4

### Fabrication of CFₓ-MWCNT Composites by Thermal Annealing

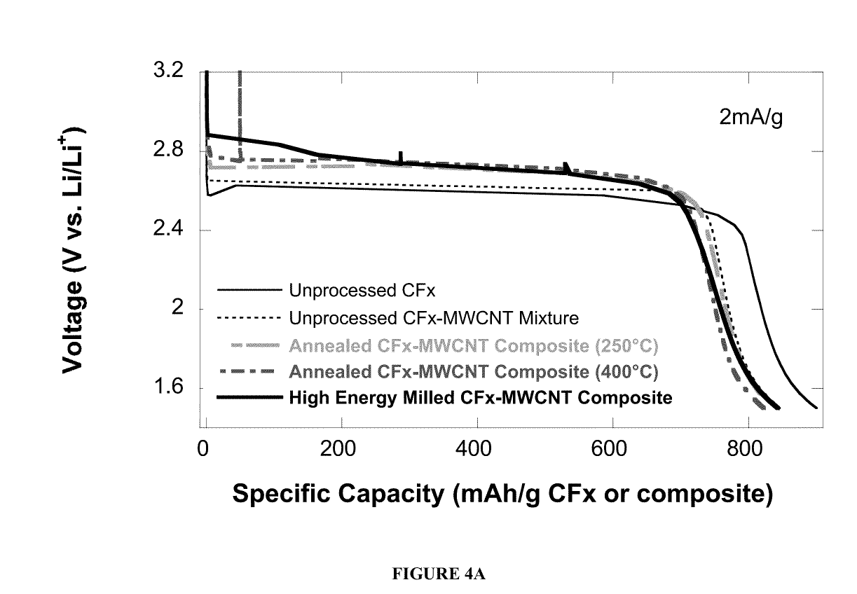

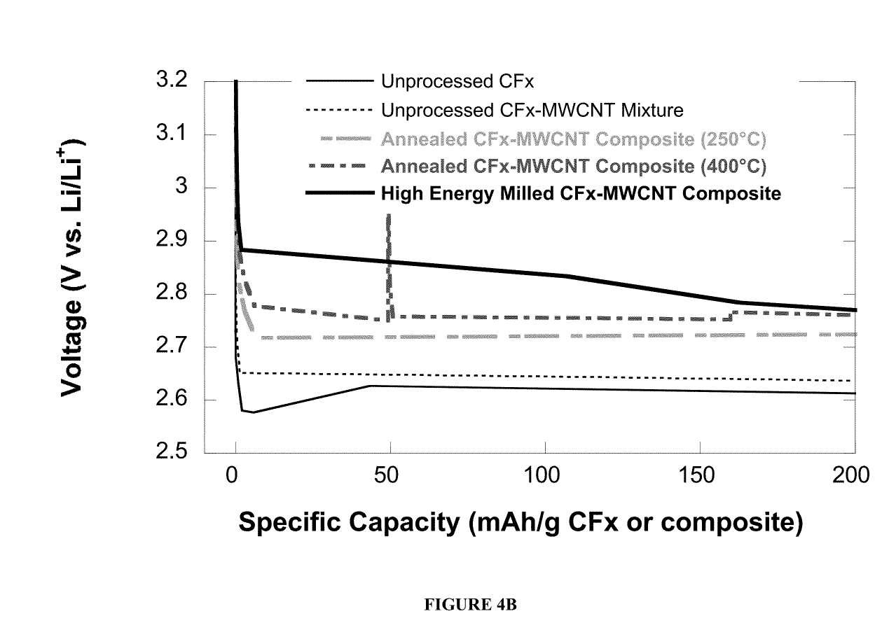

CFₓ-MWCNT composites were also fabricated by thermal annealing. Hand-mixed 94% CFₓ and 6% MWCNT blends were heat-treated for 4 hours under flowing Argon at 250° C. and 400° C., respectively. The composites exhibited improved initial voltage delay, increased OCV and increased discharge voltage compared to the pure CFₓ material (Table 3), although not as much as the high energy mixed composite (FIG. 4 for materials pending discharge completion). The synthesis temperature directly impacted electrochemical performance with discharge voltage increasing with higher synthesis temperature.

Table 3 shows the OCV and the discharge voltage under 2 mA/g load at 100 mAh/g and 400 mA/g capacity, illustrating low and high energy synthesized composites with MWCNT compared to the unprocessed CFₓ compound, and the unprocessed CFₓ-MWCNT material mixture.

TABLE 3

| | | 2 mA/g Discharge | |
|---|---|---|---|
| | | V | V |
| | | at | at |
| | OCV | 100 mAh/g | 400 mAh/g |
| Unprocessed CFₓ | 3.24 V | 2.62 V | 2.59 V |
| Unprocessed CFₓ/MWCNT Mixture | 3.36 V | 2.64 V | 2.62 V |
| Low Energy CFₓ/MWCNT Composite | 3.42 V | 2.72 V | 2.71 V |
| Synthesized at 250° C. | | | |
| Low Energy CFₓ/MWCNT Composite | 3.48 V | 2.76 V | 2.73 V |
| Synthesized at 400° C. | | | |
| High Energy CFₓ/MWCNT Composite | 3.59 V | 2.84 V | 2.72 V |

### Example 5

### Crystallographic Changes

X-ray diffraction patterns were obtained from powder samples between 8.5 and 60° 2-theta with a 0.02° 2-theta step-size at 19 second per step. FIG. 5 shows high energy milling and thermal annealing synthesized CFₓ-MWCNT composites compared to the hand mixed (and therefore “unprocessed”) CFₓ-MWCNT material and the pure CFₓ compound. While all compounds exhibited a broad diffraction feature, the (100):(001) (i.e. (H00):(00L)) ratio of the CFₓ phase increased upon material transformation. The magnitude of the Bragg peak ratio relative to the initial ratio scales inversely with the degree of reaction and subsequent material improvement.

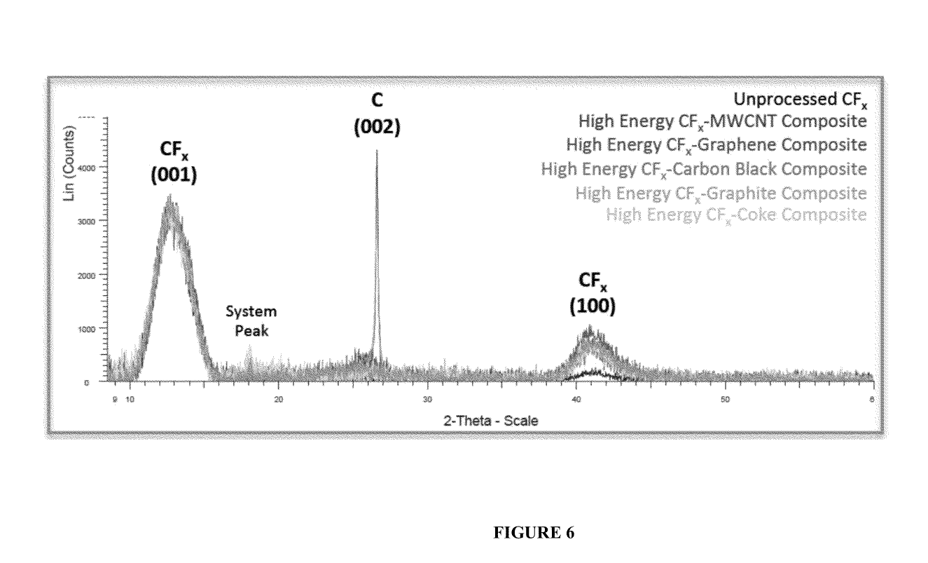

X-ray diffraction patterns were obtained from powder samples between 8.5 and 60° 2-theta with a 0.02° 2-theta step-size at 1.9 second per step. FIG. 6 shows the high energy synthesized composites processed from MWCNT, graphene, graphite, coke and carbon black referenced to the unprocessed carbon fluoride material. While all compounds exhibited a broad diffraction feature, the (100):(001) (i.e. (H00):(00L)) ratio of the carbon fluoride phase increased upon material transformation as compared to the unprocessed carbon fluoride material.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials have been described. All publications mentioned herein are incorporated herein by reference to disclose and described the methods and/or materials in connection with which the publications are cited.

The publications discussed herein are provided solely for their disclosure prior to the filing date of the present application and each is incorporated by reference in its entirety. Nothing herein is to be construed as an admission that the present invention is not entitled to antedate such publication by virtue of prior invention. Further, the dates of publication provided may be different from the actual publication dates which may need to be independently confirmed.

While a number of embodiments of the present invention have been described, it is understood that these embodiments are illustrative only, and not restrictive, and that many modifications may become apparent to those of ordinary skill in the art. In addition, many modifications may be made to adopt a particular situation, material, composition of matter, process, process step or steps, to the objective spirit and scope of the described invention. All such modifications are intended to be within the scope of the claims appended hereto.

What is claimed is:

1. A composition, comprising:
a composite including
(i) a carbon fluoride component comprising a CFₓ material, wherein x≧1, and having a first electrochemical property, and
(ii) a carbonaceous material component having a second electrochemical property,
wherein the carbon fluoride component is 70 wt % to 99 wt % based on a total weight of the composite,
wherein the carbonaceous material component is 1 wt % to 30 wt % based on the total weight of the composite, and
wherein the composite is adapted to react with energy applied thereto, and wherein, upon such reaction, the composite provides a third electrochemical property that is higher than the first electrochemical property, higher than the second electrochemical property, and higher than a combination of the first and second electrochemical properties.

2. The composition of claim 1, wherein each of the first, second and third electrochemical properties is open circuit voltage.

3. The composition of claim 1, wherein each of the first, second and third electrochemical properties is power density.

4. The composition of claim 1, wherein each of the first, second and third electrochemical properties is average discharge voltage.

5. The composition of claim 1, wherein the carbonaceous material component includes a single wall carbon nanotube.

6. The composition of claim 1, wherein the carbonaceous material component includes a multi-walled carbon nanotube.

7. The composition of claim 1, wherein the carbonaceous material component includes a material selected from the group consisting of carbon black, graphite, coke, graphene, and hard carbon.

8. The composite of claim 1, wherein a specific capacity of the composite is within a range of 500 mAh/g and 1000 mAh/g.

9. The composition of claim 1, wherein a first x-ray diffraction derived (100):(001) Bragg reflection integrated intensity ratio of the composite is greater than a second x-ray diffraction derived (100):(001) Bragg reflection integrated intensity ratio of the carbon fluoride component.

10. The composition of claim 1, wherein an open circuit voltage of the composite is ≧3.4V when compared to Li/Li⁺.

11. The composition of claim 1, wherein a first open circuit voltage of the composite is ≧3.4V when compared to Li/Li⁺ and wherein a second open circuit voltage of the carbon fluoride material is <3.4V when compared to Li/Li⁺.

12. The composition of claim 1, wherein a first discharge voltage of the composite is ≧0.1V under a constant current of 2 mA/g when compared to second discharge voltage of the carbon fluoride component under a constant current of 2 mA/g, wherein the first discharge voltage and the second discharge voltage are measured at or below a 50% depth of discharge.

13. The composition of claim 1, wherein the composite on average is comprised of domains <100 nm of CFₓ.

14. A composition, comprising:
a sufficient first amount of a carbon fluoride component comprising a CFₓ material, wherein x≧1, and having a first electrochemical property; and
a sufficient second amount of a carbonaceous material component having a second electrochemical property,
wherein the first amount of a carbon fluoride component and the second amount of carbonaceous material form a composite,
wherein the composite includes a third electrochemical property that is higher than the first electrochemical property, higher than the second electrochemical property, and higher than a combination of the first and second electrochemical properties.

15. The composition of claim 14, wherein each of the first, second and third electrochemical properties is open circuit voltage.

16. The composition of claim 14, wherein each of the first, second and third electrochemical properties is power density.

17. The composition of claim 14, wherein each of the first, second and third electrochemical properties is average discharge voltage.

18. The composition of claim 14, wherein a specific capacity of the composite is within a range of 500 mAh/g and 1000 mAh/g.

19. The composition of claim 14, wherein a first x-ray diffraction derived (100):(001) Bragg reflection integrated intensity ratio of the composite is greater than a second x-ray diffraction derived (100):(001) Bragg reflection integrated intensity ratio of the carbon fluoride component.

20. The composition of claim 14, wherein a first open circuit voltage of the composite is ≧3.4V when compared to Li/Li⁺.

21. The composition of claim 14, wherein a first open circuit voltage of the composite is ≧3.4V when compared to Li/Li⁺ and wherein a second open circuit voltage of the carbon fluoride material is <3.4V when compared to Li/Li⁺.

22. The composition of claim 14, wherein a first discharge voltage of the composite is ≧0.1V under a constant current of 2 mA/g when compared to second discharge voltage of the carbon fluoride component under a constant current of 2 mA/g, wherein the first discharge voltage and the second discharge voltage are measured at or below a 50% depth of discharge.

23. The composition of claim 14, wherein the sufficient first amount of the carbon fluoride component is 70 wt % to 99 wt % based on a total weight of the composite.

24. The composition of claim 14, wherein the sufficient second amount of the carbonaceous material component is 1 wt % to 30 wt % based on the total weight of the composite.

25. A method comprising:
selecting a carbon fluoride component comprising a CFₓ material, wherein x≧1, having a first electrochemical property,
selecting a carbonaceous material component having a second electrochemical property;
mixing the carbon fluoride component and the carbonaceous material component to form a mixture;
wherein the carbon fluoride component is 70 wt % to 99 wt % based on a total weight of the mixture;
wherein the carbonaceous material component is 1 wt % to 30 wt % based on the total weight of the mixture; and
subjecting the mixture to energy, resulting in the mixture having a third electrochemical property that is higher than the first electrochemical property, higher than the second electrochemical property, and higher than a combination of the first and second electrochemical properties.

26. The method of claim 25, wherein the step of subjecting the mixture to energy includes subjecting the mixture to thermal energy.

27. The method of claim 25, wherein the thermal energy is provided by an annealing process.

28. The method of claim 27, wherein the annealing process is performed at a temperature ranging from 150° C. to 900° C.

29. The method of claim 25, wherein the step of subjecting the mixture to energy includes subjecting the mixture to mechanical energy.

30. The method of claim 29, wherein the mechanical energy is provided by milling.

31. The method of claim 25, wherein each of the first, second and third electrochemical properties is open circuit voltage.

32. The method of claim 25, wherein each of the first, second and third electrochemical properties is power density.

33. The method of claim 25, wherein each of the first, second and third electrochemical properties is average discharge voltage.
